(19) United States
(12) Patent Application Publication
(10) Pub. No.: US 2018/0129473 A1
(43) Pub. Date: May 10, 2018

(54) FAST STICKY GENERATION IN A FAR PATH OF A FLOATING POINT ADDER

(71) Applicant: Samsung Electronics Co., Ltd., Suwon-si (KR)

(72) Inventor: Ashraf AHMED, Austin, TX (US)

(21) Appl. No.: 15/423,578

(22) Filed: Feb. 2, 2017

Related U.S. Application Data
(60) Provisional application No. 62/418,172, filed on Nov. 4, 2016.

(51) Int. Cl. G06F 7/485; G06F 5/01

(52) U.S. Cl. CPC G06F 7/485; G06F 2205/06; G06F 2207/483; G06F 5/012

(57) ABSTRACT

According to one general aspect, an apparatus may include a floating-point addition unit configured to generate a floating point result by either adding or subtracting two floating point operands together, wherein each floating point operand includes a mantissa portion and an exponent portion. The floating-point addition unit may include a mantissa shifting circuit configured to shift the mantissa portion of a smaller of the two floating point operands, and a sticky bit circuit configured to determine a sticky bit in parallel with the mantissa shifting circuit.

### CROSS-REFERENCE TO RELATED APPLICATION

This application claims priority under 35 U.S.C. § 119 to Provisional Patent Application Ser. No. 62/418,172, entitled “Fast Sticky Generation in a Far Path of a Floating Point Adder” filed on Nov. 4, 2016. The subject matter of this earlier filed application is hereby incorporated by reference

### TECHNICAL FIELD

This description generally relates to electronic circuits, and more specifically, to a system and method for fast sticky generation in a far path of a floating point adder.

### BACKGROUND

In computing, a floating point number generally includes a technique for representing an approximation of a real number in a way that can support a wide range of values. These numbers are, in general, represented approximately to a fixed number of significant digits and scaled using an exponent. The term “floating point” refers to the fact that a number's radix point (e.g., decimal point, or, more commonly in computers, binary point) can “float”; that is, it can be placed anywhere relative to the significant digits of the number. This position is indicated as the exponent component in the internal representation, and floating point can thus be thought of as a computer realization of scientific notation (e.g., 1.234×10⁴ versus 1,234, and so on).

The Institute of Electrical and Electronics Engineers (IEEE) Standard for Floating-Point Arithmetic (IEEE 754) is a technical standard for floating-point computation established in 1985 by the IEEE. Many hardware floating point units or circuits are substantially compliant with the IEEE 754 standard. Herein, the term “IEEE 754” refers to standards substantially complaint with the IEEE Standard for Floating-Point Arithmetic, IEEE Std. 754-2008 (29 Aug. 2008) or standards derived from or preceding that standard.

The IEEE 754 standard allows for various degrees of precision. The two more common levels of precision include a 32-bit (single) and 64-bit (double) precision. The 32-bit version of a floating point number includes a 1-bit sign bit (that indicates whether the number is positive or negative), an 8-bit exponent portion (that indicates the power of 2 where the radix point is located) and a 23-bits fraction, significand, or mantissa portion (that indicates the real number that is to be multiplied by 2 raised to the power of the exponent portion). The 64-bit version includes a 1-bit sign indicator, 11-bit exponent portion, and a 52-bit fraction portion. It is understood that the above are merely a few illustrative examples to which the disclosed subject matter is not limited.

### SUMMARY

According to one general aspect, an apparatus may include a floating-point addition unit configured to generate a floating point result by either adding or subtracting two floating point operands together, wherein each floating point operand includes a mantissa portion and an exponent portion. The floating-point addition unit may include a mantissa shifting circuit configured to shift the mantissa portion of a smaller of the two floating point operands, and a sticky bit circuit configured to determine a sticky bit in parallel with the mantissa shifting circuit.

According to another general aspect, a system may include a processor, and a memory. The memory may be configured to store two floating point operands. The processor may include a floating-point addition unit configured to generate a floating point result by adding two floating point operands together, wherein each floating point operand includes a mantissa portion and an exponent portion. The floating-point addition unit may include a mantissa shifting circuit configured to shift the mantissa portion of a smaller of the two floating point operands, and a sticky bit circuit configured to determine a sticky bit in parallel with the mantissa shifting circuit.

According to another general aspect, a method may include receiving two floating point operands, wherein each floating point operand includes a mantissa portion and an exponent portion The method may include determining which of the two floating point operands is a smaller floating point operand. The method may include, in parallel, shifting, via a shift register, the mantissa portion of the smaller floating point operand, and computing, via a circuit, a sticky bit. The method may include adding the mantissa portions of the two floating point operands with the sticky bit to produce a sum.

The details of one or more implementations are set forth in the accompanying drawings and the description below. Other features will be apparent from the description and drawings, and from the claims.

A system and/or method for the electrical computation of mathematical operations, substantially as shown in and/or described in connection with at least one of the figures, as set forth more completely in the claims.

### BRIEF DESCRIPTION OF THE DRAWINGS

FIG. 1 is a block diagram of an example embodiment of a floating-point adder in accordance with the disclosed subject matter.

FIG. 2 is a block diagram of an example embodiment of a far path portion of a floating-point adder in accordance with the disclosed subject matter.

FIG. 3 is a block diagram of an example embodiment of a far path portion of a floating-point adder in accordance with the disclosed subject matter.

FIG. 4 is a schematic block diagram of an information processing system, which may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, and so on may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present disclosed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

As described above, in computing devices floating point numbers are represented by a set number of bits. This means that floating point numbers may only represent a discrete and constrained part of the infinite number space as bounded by their allocated number of bits. For a normal floating-point number, the number is represented similar to standard scientific notation format, with a whole number in the significand portion of the number and the exponent portion used to indicate where the radix point should be. For example, in a decimal system 23,467 is represented as 2.3467×10⁴, where the single digit of whole number is 2 and the radix point is 4 places to the right. When a number is represented in binary, the most significant bit is always 1. It is understood that the use of scientific notation herein is used due to its relatability to the common reader, and are merely illustrative examples. It is further understood that a preferred disclosed subject matter is focused on binary numbers.

When a floating-point number is small, there are no leading zeros in the significand or fraction portion. Instead, leading zeros are removed by adjusting the exponent portion. So (in decimal) 0.0123 would be written as 1.23×10⁻² and the leading zeros would be removed.

However, according to the IEEE 754 standard, in some cases there are numbers where the floating-point notation would result in an exponent that is too small to be correctly represented. As the computing device is limited to the number of bits used to represent the exponent portion, it is possible for the value needed to indicate the proper amount of radix shift to be larger than the number of bits the computing device has available in the exponent portion of the floating point number. For example, if a floating point includes 8 bits for the exponent, the exponent may be within a range between 127 and −126. That means that if a number has an exponent smaller than −126 (e.g., 2⁻¹³⁴, and so on), the normal floating point number scheme would not be able to represent it without the possibility of significant mathematical error. Numbers such as this are referred to as “denormal numbers”, “denormalized numbers”, or “subnormal numbers”, and generally cause difficulties in computing circuits. The IEEE 754 specification provides for techniques to process and represent denormal numbers, which are not necessary to describe herein.

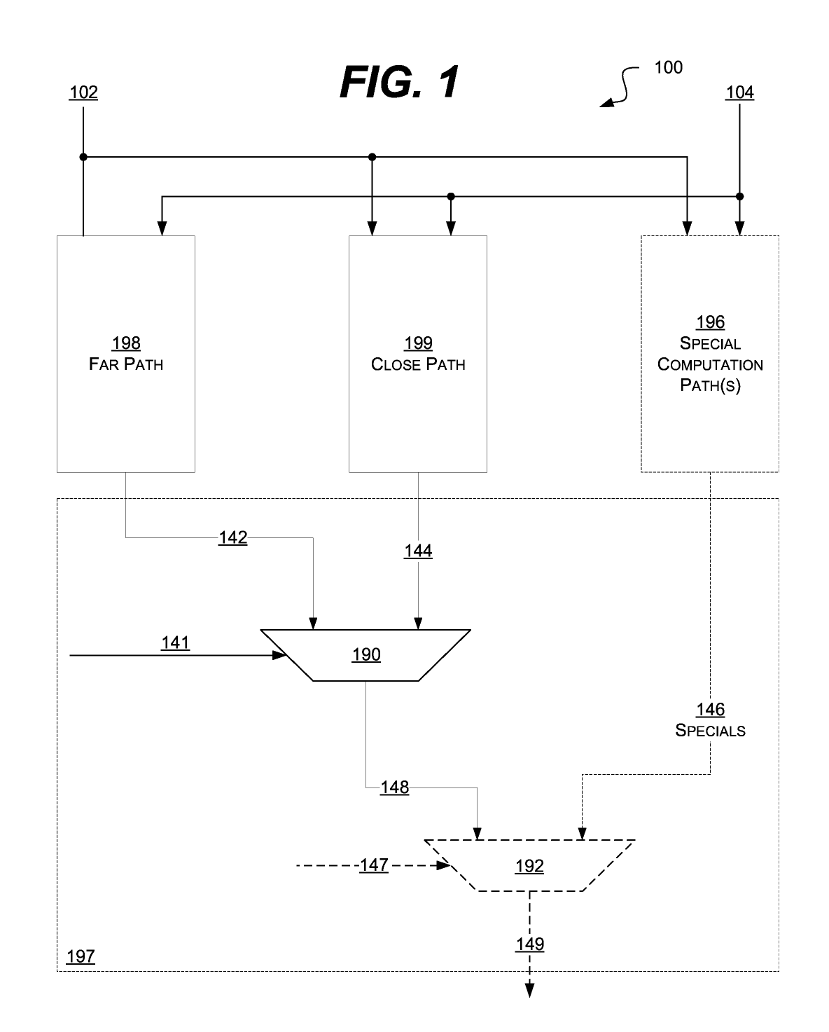

FIG. 1 is a block diagram of an example embodiment of a system or FPA (floating point adder) 100 in accordance with the disclosed subject matter. In the illustrated embodiment, system includes a floating-point addition (FPA or FADD) unit or circuit 100. In such an embodiment, the FPA 100 is configured to perform addition and/or subtraction on two floating point operands or values 102 and 104, and generate the result 148.

The FPA 100 includes three basic portions: a far path 198, a close path 199, and a selection circuit 197. In various embodiments, the far path 198 is a data path that may be configured to perform all ranges of the addition operation and/or the subtraction operation when the exponent portions of the two operands 102 and 104 differ by more than an order of magnitude (e.g., 1,234−34). More specifically, the far path 198 is used when the operation is an effective addition, or the operation is an effective subtraction and the absolute difference in the exponent portions of the operands 102 and 104 is greater than 1. Conversely, the close path 199 may be used when the operation is an effective subtraction operation and when the absolute difference exponent portion of the two operands 102 and 104 is less than or equal to one. An operation is an effective add if either: (a) the requested operation is an addition and the signs of the two operands 102 and 104 are the same, or (b) the requested operation is a subtraction and the signs of the two operands are different. An operation is an effective subtraction if neither of the above conditions are true. Or to be more specific, an operation is an effective subtraction if either: (a) the requested operation is an addition and the signs of the two operands are different, or (b) the requested operation is a sub and the signs of the two operands are the same.

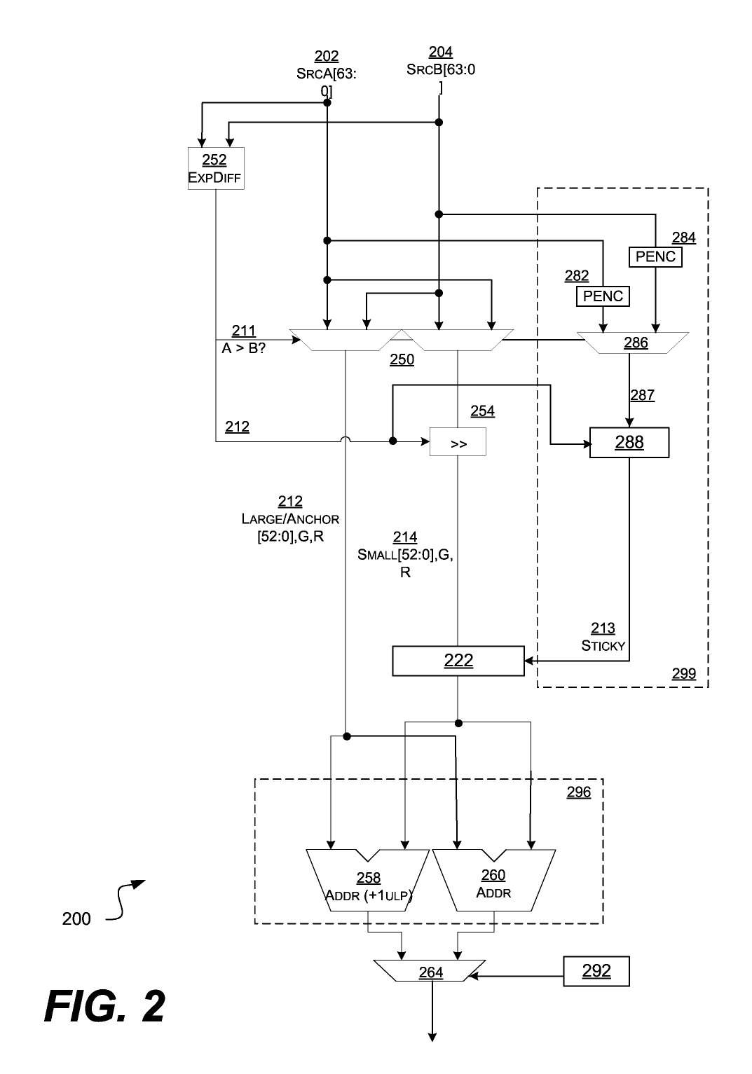

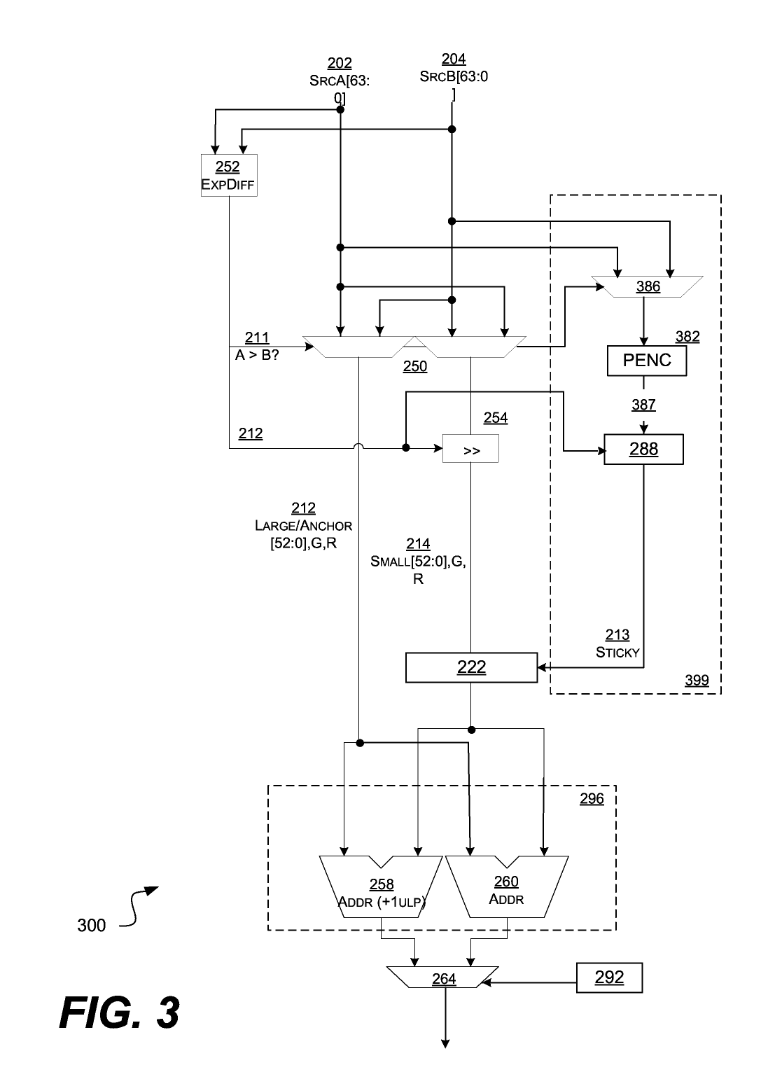

The selection circuit 197 may be configured to select between the far path result 142 and the close path result 144 to generate the final (non-special) result 148 or the ultimate result 149 (depending on the embodiment). These portions of the FPA 100 are discussed in general detail in regards to FIG. 1, and then the far path 198 is shown in greater detail in regards to FIGS. 2 and 3.

In the illustrated embodiment of FPA 100, the operands 102 and 104 are processed in parallel by the far path 198 and the close path 199 before the difference in the exponent portions of the two operands 102 and 104 is known. As a result, one of the two paths' results 142 or 144 will be inaccurate and will be discarded by the selection circuit 197 (as by that time the difference in exponent portions is known). This parallel computation has the desirable effect of increasing the speed of the computation but the less desirable effects of increasing the size of the FPA 100 and the power consumed by the FPA 100.

In the illustrated embodiment, a result selector 190 may be configured to select between the far path result 142 or the close path result 144 based upon a signal 141. In various embodiments, the signal 141 may cause the close path result 144 to be selected if, the operation is an effective subtraction operation and when the absolute difference in the exponent portion of the two operands 102 and 104 is less than or equal to one. It is understood that the above are merely a few illustrative examples to which the disclosed subject matter is not limited.

In the illustrated embodiment, the FPA 100 may include one or more special computation paths 196. Each path may be configured to compute or process one or more arithmetic exceptions. In various embodiments, the special computation paths 196 may generate one or more special results 146. In the illustrated embodiment, the ultimate result selector 192 may be configured to select between the floating point result 148 and a special result 146. In various embodiments, the FPA may not include the special computation path(s) 196 or the ultimate result selector 192. It is understood that the above is merely one illustrative example to which the disclosed subject matter is not limited.

FIG. 2 is a block diagram of an example embodiment of a far path portion 200 of a floating-point adder in accordance with the disclosed subject matter. In various embodiments, the circuit 200 may be included in a floating-point unit (FPU) in a processor or system-on-a-chip (SoC). It is understood that the above are merely a few illustrative examples to which the disclosed subject matter is not limited.

In the illustrated embodiment, the two floating point operands 202 and 204 may be input to the far path portion 200. In the illustrated embodiment, the operands 202 and 204 may include 64-bits divided amongst a mantissa portion, an exponent portion, and a sign bit. It is understood that the above are merely a few illustrative examples to which the disclosed subject matter is not limited.

In various embodiments, the far path portion 200 may include an exponent difference (ExpDiff) computation circuit 252 configured to determine which of the two operands 202 and 204 is the larger operand. This results in the size differentiation signal 211. In various embodiments, the size differentiation signal 211 may include the most significant bit (MSB) of the ExpDiff 252's output.

As is traditionally done, the two operands 202 and 204 (or at least their mantissa portions) are re-ordered or swapped, if needed, such that the larger or anchor operand 212 is placed on a desirable set of inputs for the adders 258 and 260, likewise with the smaller operand 214. This re-ordering or swapping of the operands 202 and 204 is performed by swap-multiplexers (MUXs) 250. In the illustrated embodiment, the swap MUXs 250 are controlled by the size differentiation signal 211.

In various embodiments, addition is an issue if the fraction portions of the operands are not aligned. In some embodiments, the radix point of the smaller signal 214 may be shifted, in order that the radix points of the larger operand 212 and the smaller operand 214 are aligned. In the illustrated embodiment, this may be done by the alignment or mantissa shifting circuit 254. In such an embodiment, the alignment circuit 254 may be controlled by the fuller output 212 of the ExpDiff computation circuit 252.

In the illustrated embodiment, the far path portion 200 may be configured to compute a sticky bit 213. The sticky bit circuit 299 may in such a case produce at least one sticky bit 213 that is, traditionally computed as, the value of the OR of all the bits of the smaller operand 214 that are shifted to the right of the larger operand 212's round bit. In various embodiments, the sticky bit 213 may be employed to round the result or mantissa of the addition/subtraction back to a width that (usually) matches the width of the source mantissas. In the illustrated embodiment, the sticky bit 213 and any related bits (e.g., a guard bit, a round bit) may be concatenated with the larger operand 212 and the smaller operand 214. It is understood that the above are merely a few illustrative examples to which the disclosed subject matter is not limited.

Traditionally, a sticky bit 213 is computed by passing any bits shifted out of the mantissa shifting circuit 254 through a series of OR gates, OR reduction, or an OR gate tree. This requires that the sticky bit 213 may not begin to be computed until the mantissa shifting circuit 254 is finished processing the smaller operand 254. This adds a non-trivial amount of logical/gate delay to the far path as the OR gate tree sits between the mantissa shifting circuit 254 and the conditional inversion circuit 222 or (depending upon the embodiment) the adders 258 and 260. In the case of double-precision mantissas, the OR tree may be required to process 53 input bits. It is understood that the above is merely one illustrative example to which the disclosed subject matter is not limited.

In the illustrated embodiment, the sticky bit circuit 299 may be configured to process or determine the value of the sticky bit 213 in parallel (or at least partially in parallel) with the shifting of the smaller operand 214. This may significantly reduce the Far circuit 200's overall computation time.

In one embodiment, the sticky bit circuit 299 may include one or more priority encoder circuits (PENC). In the illustrated embodiment, two PENCs 282 and 284 may be employed. In various embodiments, the PENCs 282 & 284 may be configured to detect the position of the first 1 from the right (i.e., from the least significant bit upwards) in an input vector. In such an embodiment, the PENC 282 or 284 may be configured to determine how many bits may be safely shifted out of the mantissa shifting circuit 254 before information becomes lost.

In the illustrated embodiment, the PENC 282 may take as input the mantissa portion of the first operand 202, and the PENC 284 may take as input the mantissa portion of the second operand 204. In such an embodiment, a selection circuit or MUX 286 may be configured to select the PENC output that corresponds to the smaller operand 214. In the illustrated embodiment, the control or selector signal to the MUX 286 may be the same as the control or selector signal 211 as employed by the MUXs 250.

The output of the MUX 286 (signal 287) may be input into a comparator circuit 288. In various embodiments, the comparator circuit 288 may also take as input the ExpDiff output signal 212. In various embodiments, the comparator circuit 288 may be configured to compare the result of the selected priority encoder circuit (signal 287) with the difference in the respective exponent portions of the two floating point operands (signal 212).

In one such embodiment, if the ExpDiff output 212 is smaller than or equal to the PENC value 287, then the sticky bit 213 is set to 0. In such an embodiment, the mantissa portion of small operand 214 is to be right shifted (via circuit 254) by an amount that is less than the number of trailing zeroes. Conversely, if the ExpDiff output 212 is greater than the PENC value 287, then the sticky bit 213 is set to 1. In such an embodiment, the mantissa portion of the small operand 214 is to be right shifted by an amount that exceeds the number of trailing zeroes, and information will be lost.

In the illustrated embodiment, this sticky bit 213 may be input into a conditional inversion circuit 222. In such an embodiment, the conditional inversion circuit 222 may be configured to negate (or not) the operand 214 if the mathematical operation (e.g., addition, subtraction, and so on) dictates.

In various embodiments, the operands 212 and 214 may be input into an integer addition circuit 296. In the illustrated embodiment, the integer addition circuit 296 may include a pair of integer adders 258 and 260. In one embodiment, a first adder 258 may assume there is no overflow in the addition, and a second adder 260 may assume there will be an overflow in the addition, or in the case of subtraction, may assume there will be a 1-bit shift.

As described above, in various embodiments, these two integer adders 258 and 260 may be employed in parallel to increase the speed and ease of computation. In various embodiments, an integer addition selector 264 may be employed to select between the two outputs of the adders 258 and 260. In various embodiments, the selection between the adders 258 and 260 may be based upon a selection circuit 292. In some embodiments, the selection circuit 292 may base its decision on rounding bits provided by adder 260. In another embodiment, the selection circuit 292 may base its decision on other signals created by the FAR circuit 200 (e.g., an overflow indicator and a left shift indicator, and so on). It is understood that the above are merely a few illustrative examples to which the disclosed subject matter is not limited.

FIG. 3 is a block diagram of an example embodiment of a far path portion 300 of a floating-point adder in accordance with the disclosed subject matter. In various embodiments, the circuit 300 may be included in a floating-point unit (FPU) in a processor or system-on-a-chip (SoC). In the illustrated embodiment, the far path 300 may be slightly slower, at least in part, that the faster far path 200 of FIG. 2. It is understood that the above are merely a few illustrative examples to which the disclosed subject matter is not limited.

In the illustrated embodiment, the two floating point operands 202 and 204 may be input to the circuit 300. In the illustrated embodiment, the operands 202 and 204 may include 64-bits divided amongst a mantissa portion, an exponent portion, and a sign bit. It is understood that the above are merely a few illustrative examples to which the disclosed subject matter is not limited.

In various embodiments, the circuit 300 may again include an exponent difference (ExpDiff) computation circuit 252 configured to determine which of the two operands 202 and 204 is the larger operand. This results in the size differentiation signal 211. In various embodiments, the size differentiation signal 211 may include the most significant bit (MSB) of the ExpDiff 252's output.

As is traditionally done, the two operands 202 and 204 (or at least their mantissa portions) are re-ordered or swapped, if needed, such that the larger or anchor operand 212 is placed on a desirable set of inputs for the adders 258 and 260, likewise with the smaller operand 214. This action is performed by swap-multiplexers (MUXs) 250. In the illustrated embodiment, the swap MUXs 250 are controlled by the size differentiation signal 211.

In some embodiments, the radix point of the smaller signal 214 may be shifted, in order that the radix points of the larger and smaller operands 212 and 214 are aligned. In the illustrated embodiment, this may be done by the alignment or mantissa shifting circuit 254. In such an embodiment, the alignment circuit 254 may be controlled by the fuller output 212 of the ExpDiff computation circuit 252.

Again, in the illustrated embodiment, the circuit 300 may be configured to compute a sticky bit 213. The sticky bit circuit 399 may in such a case produce at least one sticky bit 213 which is, traditionally computed as, the value of the OR of all the bits of the smaller operand 214 that are shifted to the right of the larger operand 212's round bit. In various embodiments, the sticky bit 213 may be employed to round the result or mantissa of the addition/subtraction back to a width that (usually) matches the width of the source mantissas. In the illustrated embodiment, the sticky bit 213 and any related bits (e.g., a guard bit, a round bit) may be concatenated with the larger operand 212 and the smaller operand 214. It is understood that the above are merely a few illustrative examples to which the disclosed subject matter is not limited.

In the illustrated embodiment, the sticky bit circuit 399 may be configured to process or determine the value of the sticky bit 213 in parallel (or at least partially in parallel) with the shifting of the smaller operand 214. This may significantly reduce the Far circuit 200's overall computation time.

In one embodiment, the sticky bit circuit 299 may include a selection circuit or MUX 386 may be configured to select the mantissa portion of the smaller operand 214. In the illustrated embodiment, the control or selector signal to the MUX 386 may be the same as the control or selector signal 211 as employed by the MUXs 250.

In some embodiments, the far path may completely eschew a separate MUX 386 and instead route the small operand 214 to the PENC 382 directly from the swap MUXs 250. It is understood that the above is merely one illustrative example to which the disclosed subject matter is not limited.

In the illustrated embodiment, the far path 200 may include a single priority encoder circuits (PENC) 382. In the illustrated embodiment, it may receive the mantissa portion of the smaller operand (either from the MUX 386 or MUX 250). In various embodiments, the PENC 382 may be configured to detect the position of the first 1 from the right (i.e., from the least significant bit upwards)in an input vector. In such an embodiment, the PENC 382 may be configured to determine how many bits may be safely shifted out of the mantissa shifting circuit 254 before information becomes lost.

The output of the PENC 382 may be input into a comparator circuit 288. In various embodiments, the comparator circuit 288 may also take as input the ExpDiff output signal 212. In various embodiments, the comparator circuit 288 may be configured to compare the result of the priority encoder circuit 382 (signal 387) with the difference in the respective exponent portions of the two floating point operands (signal 212).

In one such embodiment, if the ExpDiff output 212 is smaller than or equal to the PENC value 387, then the sticky bit 213 is set to 0. In such an embodiment, the mantissa portion of small operand 214 is to be right shifted (via circuit 254) by an amount that is less than the number of trailing zeroes. Conversely, if the ExpDiff output 212 is greater than the PENC value 387, then the sticky bit 213 is set to 1. In such an embodiment, the mantissa portion of the small operand 214 is to be right shifted by an amount that exceeds the number of trailing zeroes, and information will be lost.

In the illustrated embodiment, this sticky bit 213 may be input into a conditional inversion circuit 222. In such an embodiment, the conditional inversion circuit 222 may be configured to negate (or not) the operand 214 if the mathematical operation (e.g., addition, subtraction, and so on) dictates.

In various embodiments, the operands 212 and 214 may be input into an integer addition circuit 296. In the illustrated embodiment, the integer addition circuit 296 may include a pair of integer adders 258 and 260. In one embodiment, a first adder 258 may assume there is no overflow in the addition, and a second adder 260 may assume there will be an overflow in the addition, or in the case of subtraction, may assume there will be a 1-bit shift.

As described above, in various embodiments, these two integer adders 258 and 260 may be employed in parallel to increase the speed and ease of computation. In various embodiments, an integer addition selector 264 may be employed to select between the two outputs of the adders 258 and 260. In various embodiments, the selection between the adders 258 and 260 may be based upon a selection circuit 292. In some embodiments, the selection circuit 292 may base its decision on rounding bits provided by adder 260. In another embodiment, the selection circuit 292 may base its decision on other signals created by the FAR circuit 200 (e.g., an overflow indicator and a left shift indicator, and so on). It is understood that the above are merely a few illustrative examples to which the disclosed subject matter is not limited.

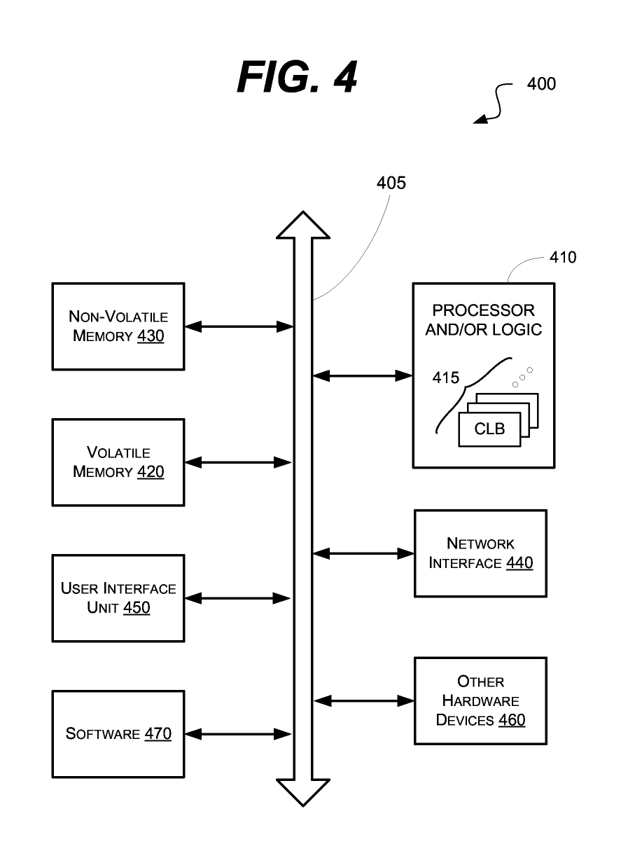

FIG. 4 is a schematic block diagram of an information processing system 400, which may include semiconductor devices formed according to principles of the disclosed subject matter.

Referring to FIG. 4, an information processing system 400 may include one or more of devices constructed according to the principles of the disclosed subject matter. In another embodiment, the information processing system 400 may employ or execute one or more techniques according to the principles of the disclosed subject matter.

In various embodiments, the information processing system 400 may include a computing device, such as, for example, a laptop, desktop, workstation, server, blade server, personal digital assistant, smartphone, tablet, and other appropriate computers, and so on or a virtual machine or virtual computing device thereof. In various embodiments, the information processing system 400 may be used by a user (not shown).

The information processing system 400 according to the disclosed subject matter may further include a central processing unit (CPU), logic, or processor 410. In some embodiments, the processor 410 may include one or more functional unit blocks (FUBs) or combinational logic blocks (CLBs) 415. In such an embodiment, a combinational logic block may include various Boolean logic operations (e.g., NAND, NOR, NOT, XOR, and so on), stabilizing logic devices (e.g., flip-flops, latches, and so on), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 400 according to the disclosed subject matter may further include a volatile memory 420 (e.g., a Random Access Memory (RAM), and so on). The information processing system 400 according to the disclosed subject matter may further include a non-volatile memory 430 (e.g., a hard drive, an optical memory, a NAND or Flash memory, and so on). In some embodiments, either the volatile memory 420, the non-volatile memory 430, or a combination or portions thereof may be referred to as a “storage medium”. In various embodiments, the volatile memory 420 and/or the non-volatile memory 430 may be configured to store data in a semi-permanent or substantially permanent form.

In various embodiments, the information processing system 400 may include one or more network interfaces 440 configured to allow the information processing system 400 to be part of and communicate via a communications network. Examples of a Wi-Fi protocol may include, but are not limited to, Institute of Electrical and Electronics Engineers (IEEE) 802.11g, IEEE 802.11n. Examples of a cellular protocol may include, but are not limited to: IEEE 802.16m (a.k.a. Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), and so on Examples of a wired protocol may include, but are not limited to, IEEE 802.3 (a.k.a. Ethernet), Fibre Channel, Power Line communication (e.g., HomePlug, IEEE 1901, and so on), and so on It is understood that the above are merely a few illustrative examples to which the disclosed subject matter is not limited.

The information processing system 400 according to the disclosed subject matter may further include a user interface unit 450 (e.g., a display adapter, a haptic interface, a human interface device, and so on). In various embodiments, this user interface unit 450 may be configured to either receive input from a user and/or provide output to a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In various embodiments, the information processing system 400 may include one or more other devices or hardware components 460 (e.g., a display or monitor, a keyboard, a mouse, a camera, a fingerprint reader, a video processor, and so on). It is understood that the above are merely a few illustrative examples to which the disclosed subject matter is not limited.

The information processing system 400 according to the disclosed subject matter may further include one or more system buses 405. In such an embodiment, the system bus 405 may be configured to communicatively couple the processor 410, the volatile memory 420, the non-volatile memory 430, the network interface 440, the user interface unit 450, and one or more hardware components 460. Data processed by the processor 410 or data inputted from outside of the non-volatile memory 430 may be stored in either the non-volatile memory 430 or the volatile memory 420.

In various embodiments, the information processing system 400 may include or execute one or more software components 470. In some embodiments, the software components 470 may include an operating system (OS) and/or an application. In some embodiments, the OS may be configured to provide one or more services to an application and manage or act as an intermediary between the application and the various hardware components (e.g., the processor 410, a network interface 440, and so on) of the information processing system 400. In such an embodiment, the information processing system 400 may include one or more native applications, which may be installed locally (e.g., within the non-volatile memory 430, and so on) and configured to be executed directly by the processor 410 and directly interact with the OS. In such an embodiment, the native applications may include pre-compiled machine executable code. In some embodiments, the native applications may include a script interpreter (e.g., C shell (csh), AppleScript, AutoHotkey, and so on) or a virtual execution machine (VM) (e.g., the Java Virtual Machine, the Microsoft Common Language Runtime, and so on) that are configured to translate source or object code into executable code which is then executed by the processor 410.

The semiconductor devices described above may be encapsulated using various packaging techniques. For example, semiconductor devices constructed according to principles of the disclosed subject matter may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive, and so on). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. An apparatus comprising:
a floating-point addition unit configured to generate a floating point result by either adding or subtracting two floating point operands together, wherein each floating point operand includes a mantissa portion and an exponent portion; and
the floating-point addition unit comprising:
a mantissa shifting circuit configured to shift the mantissa portion of a smaller of the two floating point operands; and
a sticky bit circuit configured to determine a sticky bit in parallel with the mantissa shifting circuit.

2. The apparatus of claim 1, wherein the sticky bit circuit comprises:
two priority encoder circuits configured to each indicate the number of bits that may be safely shifted from the least significant bits of a respective one of the two floating point operands;
a selector circuit configured to select the output of the priority encoder circuit associated with smaller of the two floating point operands.

3. The apparatus of claim 1, wherein the sticky bit circuit comprises:
a priority encoder circuit configured to indicate the number of bits that may be safely shifted from the smaller of the two floating point operands; and
a comparator configured to compare a result of the priority encoder circuit with a difference in the respective exponent portions of the two floating point operands.

4. The apparatus of claim 3, wherein the comparator is configured to:
if the difference in the respective exponent portions is less than or equal to the result of the priority encoder circuit, set the sticky bit to zero; and
if the difference in the respective exponent portions is greater than the result of the priority encoder circuit, set the sticky bit to one.

5. The apparatus of claim 1, wherein the sticky bit circuit does not include an OR gate tree.

6. The apparatus of claim 1, wherein a sticky bit circuit configured to determine a sticky bit without taking as input the output of the mantissa shifting circuit.

7. The apparatus of claim 1, wherein a floating-point addition unit comprises:
a far path circuit configured to compute a far path result based upon either the addition or the subtraction of the two floating point numbers; and
a close path circuit configured to compute a close path result based upon the subtraction of the two floating point operands;
wherein the far path circuit comprises a mantissa shifting circuit and the sticky bit circuit.

8. A system comprising:
a memory configured to store two floating point operands; and
a processor comprising
a floating-point addition unit configured to generate a floating point result by adding two floating point operands together, wherein each floating point operand includes a mantissa portion and an exponent portion; and
the floating-point addition unit comprising:
a mantissa shifting circuit configured to shift the mantissa portion of a smaller of the two floating point operands, and
a sticky bit circuit configured to determine a sticky bit in parallel with the mantissa shifting circuit.

9. The system of claim 8, wherein the sticky bit circuit comprises:
two priority encoder circuits configured to each indicate the number of bits that may be safely shifted from a respective one of the two floating point operands;
a selector circuit configured to select the output of the priority encoder circuit associated with smaller of the two floating point operands.

10. The system of claim 8, wherein the sticky bit circuit comprises:
a priority encoder circuit configured to indicate the number of bits that may be safely shifted from the smaller of the two floating point operands; and
a comparator configured to compare a result of the priority encoder circuit with a difference in the respective exponent portions of the two floating point operands.

11. The system of claim 10, wherein the comparator is configured to:
if the difference in the respective exponent portions is less than or equal to the result of the priority encoder circuit, set the sticky bit to zero; and
if the difference in the respective exponent portions is greater than the result of the priority encoder circuit, set the sticky bit to one.

12. The system of claim 8, wherein the sticky bit circuit does not include an OR gate tree.

13. The system of claim 8, wherein a sticky bit circuit configured to determine a sticky bit without taking as input the output of the mantissa shifting circuit.

14. The system of claim 8, wherein a floating-point addition unit comprises:
a far path circuit configured to compute a far path result based upon either the addition or the subtraction of the two floating point numbers; and
a close path circuit configured to compute a close path result based upon the subtraction of the two floating point operands;
wherein the far path circuit comprises a mantissa shifting circuit and the sticky bit circuit.

15. A method comprising:
receiving two floating point operands, wherein each floating point operand includes a mantissa portion and an exponent portion;
determining which of the two floating point operands is a smaller floating point operand;
in parallel, shifting, via a shift register, the mantissa portion of the smaller floating point operand, and computing, via a circuit, a sticky bit; and
adding the mantissa portions of the two floating point operands with the sticky bit to produce a sum.

16. The method of claim 15, wherein computing the sticky bit comprises:
determining, via a priority encoder circuit, the number of bits that may be safely shifted from each of the two floating point operands; and
selecting an output of the priority encoder circuit associated with smaller of the two floating point operands.

17. The method of claim 15, wherein computing the sticky bit comprises:
determining, via a priority encoder circuit, the number of bits that may be safely shifted from the smaller floating point operand; and
comparing a result of the priority encoder circuit with a difference in the respective exponent portions of the two floating point operands.

18. The method of claim 17, wherein the computing the sticky bit comprises:
if the difference in the respective exponent portions is less than or equal to the result of the priority encoder circuit, setting the sticky bit to zero; and
if the difference in the respective exponent portions is greater than the result of the priority encoder circuit, setting the sticky bit to one.

19. The method of claim 15, wherein computing the sticky bit comprises not employing an OR tree.

20. The method of claim 15, wherein the computing the sticky bit comprises computing the sticky bit without taking as input an output of the shift register.
